(19) United States
(12) Patent Application Publication
(10) Pub. No.: US 2011/0273500 A1
(43) Pub. Date: Nov. 10, 2011

(54) LIQUID EJECTING APPARATUS

(75) Inventors: Hiroyuki Ishikawa, Shiojiri-shi (JP); Yasuo Sunaga, Matsumoto-shi (JP)

(73) Assignee: Seiko Epson Corporation, Shinjuku-ku (JP)

(21) Appl. No.: 13/103,800

(22) Filed: May 9, 2011

(30) Foreign Application Priority Data
May 10, 2010 (JP) 2010-108203

(51) Int. Cl. B41J 29/38

(52) U.S. Cl. 347/10

(57) ABSTRACT

A liquid ejecting apparatus includes a liquid ejecting head with a plurality of nozzle groups each having a plurality of nozzles. Each nozzle ejects a liquid onto a landing target by an ejection pulse applied to the liquid. A movement unit relatively moves the liquid ejecting head and the landing target. A control unit sets an ejection timing of the liquid from the nozzles for each nozzle group according to a distance between the nozzles and the landing target. A driving signal generation unit generates driving signals including the ejection pulses, where a timing of each ejection pulse is based on the distance and a speed of the liquid as the liquid crosses the distance. The control unit selects the driving signal for each nozzle group based on the distance and applies a corresponding ejection pulse to the liquid. A liquid ejecting method is also provided.

This application claims priority to Japanese Patent Application No. 2010-108203, filed May 10, 2010, the entirety of which is incorporated by reference herein.

### BACKGROUND

1. Technical Field

The present invention relates to a liquid ejecting apparatus such as an ink jet printer, and more particularly, to a liquid ejecting apparatus capable of ejecting liquid to a desired landing position on a landing target.

2. Related Art

A liquid ejecting apparatus is an apparatus which includes a liquid ejecting head that ejects a liquid from nozzles. A representative liquid ejecting apparatus is an image recording apparatus, such as an ink jet printer, which includes an ink jet recording head. Such a printer records an image or the like by ejecting liquid ink onto a recording sheet, from nozzles of the recording head. Liquid ejecting apparatuses are not limited to printers; in recent years various types of manufacturing apparatuses, such as those manufacturing color filters such as liquid crystal displays have been developed.

In an ink jet printer, an ink jet recording head ejects ink droplets by supplying an ejection pulse, and a head scanning mechanism moves the recording head in the width direction of a recording medium, for example paper (a main scanning direction). The ink droplets are ejected in both the forward movement and backward movement directions of the recording head.

When the ink is ejected from the nozzles, the speed of the ink in the direction perpendicular to the nozzle surface of the recording head varies due to the influence of air resistance until the ink lands on the recording medium. The degree of the change in the speed depends on the distance between the nozzle and the landing position on the recording medium. The distance may change during the head's travel, if a so-called cockling effect occurs, in which the recording sheet curves or ripples from absorbing the ink or the like.

JP-A-2009-083512 is an example of the related art.

When the landing position of the ink on the recording medium is estimated on the assumption that the speed of the ink is constant in spite of the change in the distance between the nozzle of the recording head and the recording medium, the ink does not land at the intended position. As a consequence, the image quality suffers. Moreover, such a problem occurs not only in ink jet recording apparatuses but also other liquid ejecting apparatuses.

### SUMMARY

An advantage of some aspects of the invention is that it provides a liquid ejecting apparatus capable of adjusting landing positions of a liquid ejected from nozzles onto a landing target even when the distance between the nozzles and the landing target varies.

According to an aspect of the invention, there is provided a liquid ejecting apparatus including: a liquid ejecting head including a plurality of nozzle groups, which each have a plurality of nozzles ejecting a liquid onto a landing target by applying an ejection pulse to the liquid. The apparatus further includes a driving signal generation unit which generates a driving signal including the ejection pulse; a movement unit that moves the liquid ejecting head relative to the landing target; and a control unit that selects an ejection timing of the liquid from the nozzles for each nozzle group according to a distance between the liquid ejecting head and the landing target. The driving signal generation unit generates the driving signals, in which timing of the ejection pulse is set based on the distance, and a speed of the liquid as it moves through the distance, in accordance with a finite number of discrete, predetermined distances. The control unit selects the driving signal for each nozzle group based on the distance. The speed may be determined based on the time that the liquid takes to cross the distance, and the relative speed between the liquid ejecting head and the landing target.

The distance between the nozzle and the ejection target refers to a vertical distance between the nozzle from which the liquid is ejected and the intended landing position of the liquid on the ejection target.

In some embodiments, the driving signal is selected for each nozzle group based on the distance between the nozzle and the ejection target and the liquid is ejected based on the corresponding driving signal. Therefore, even when curving or the like occurs in the ejection target and thus the distance between the nozzle and the landing target varies depending on the position in the relative movement direction, the ejection timing is selected so that the liquid lands on the intended position on the ejection target. Accordingly, the variation in the landing position of the liquid on the ejection target is suppressed in each nozzle group. As a consequence, when an image or the like is recorded on the landing target, the image quality is high, thus minimizing deteriorating effects.

In some embodiments, a plurality of ejection modes may be selected. The timing of the ejection pulse of the driving signal may be set for each ejection mode. The control unit may select the driving signal for each ejection mode and each nozzle group.

Here, the “ejection mode” refers to various kinds of modes in which the amount of ejected liquid is different depending on usages. Examples of the ejection mode include a mode in which the liquid lands in a range broader than the landing target by increasing the amount of liquid ejected from the nozzle and a predetermined range on the landing target is filled with the liquid more rapidly, and a mode in which the liquid lands on a range narrower than the landing target by reducing the amount of liquid ejected from the nozzle and a more minute image or the like is formed.

With such a configuration, it is possible to eject the ink at a more appropriate timing in each ejection mode, even when the amount of liquid ejected from the nozzle is different. Thus, the landing position can be more accurate for each ejection mode, thus variations in the landing position are suppressed or minimized.

In some embodiments, the driving signal may include ejection pulses having sizes different from each other to set the size of a dot formed by the liquid. Different sizes of ink droplets may have different speeds due to differences in air resistance or the like. Therefore, in some embodiments, timing may be set differently for each ejection pulse.

With such a configuration, it is possible to eject the liquid at a more appropriate timing, taking into account size of the dot formed on the landing target. Accordingly, it is possible to suppress the variation in the landing position due to the difference in the size of the dot.

The speed of the liquid used in selecting the driving signal may be an average speed between the liquid ejecting head and the landing target.

With such a configuration, it is possible to adjust the landing position of the liquid to an appropriate position, even when the speed of the liquid changes.

### BRIEF DESCRIPTION OF THE DRAWINGS

The invention will be described with reference to the accompanying drawings, wherein like numbers reference like elements.

FIG. 1 is a block diagram illustrating the electric configuration of a printer.

FIG. 2 is a perspective view illustrating the inner configuration of the printer.

FIG. 3 is a sectional view illustrating the main elements of a recording head.

FIG. 4 is a plan view illustrating the configuration of a nozzle plate.

FIG. 5 is a schematic diagram illustrating variation of the landing position of ink and timing adjustment.

FIG. 6A is a graph illustrating an average speed of the ink for a gap.

FIG. 6B is a table illustrating the average speed of the ink for the gap.

FIG. 7A is a graph illustrating an arrival time of the ink in the gap.

FIG. 7B is a table illustrating the arrival time of the ink in the gap.

FIG. 8 is a graph illustrating a variation amount of the landing position of the ink for the gap.

FIG. 9 is a flowchart illustrating the flow of a process of adjusting the ejection timing.

FIG. 10 is a diagram illustrating the waveforms of driving signals.

FIGS. 11A to 11C are diagrams illustrating variation in the landing position when the ink is landed on the recording medium.

### DESCRIPTION OF EXEMPLARY EMBODIMENTS

Hereinafter, exemplary embodiments of the invention will be described with reference to the accompanying drawings. The embodiments are described below with reference to various specific examples, but the scope of the invention should not be construed as being limited to the embodiments described and illustrated herein unless the description clearly states otherwise. Hereinafter, an ink jet printer will be described as an example of a liquid ejecting apparatus.

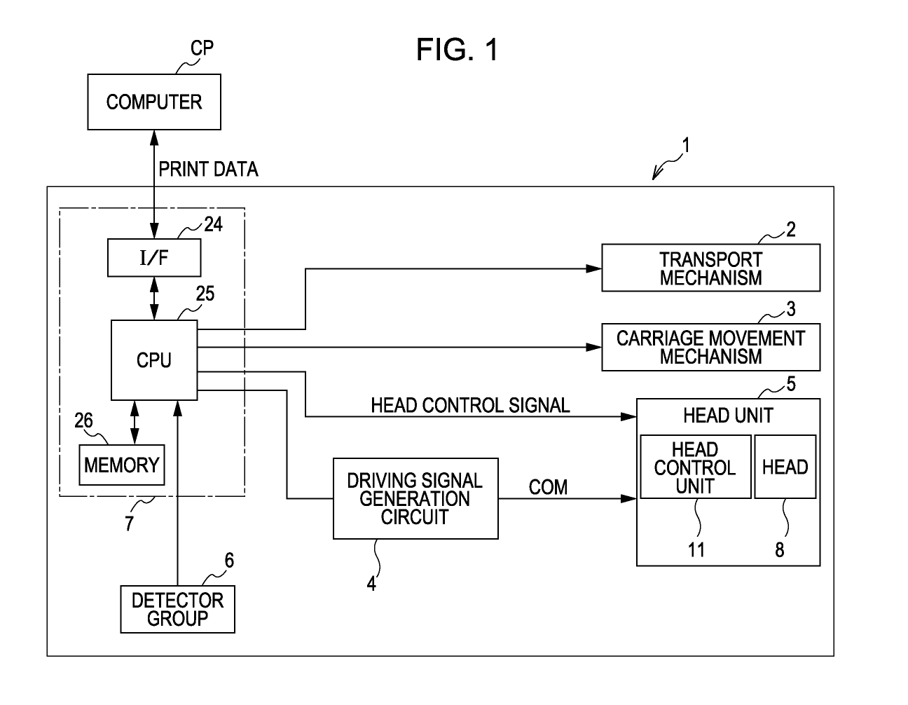

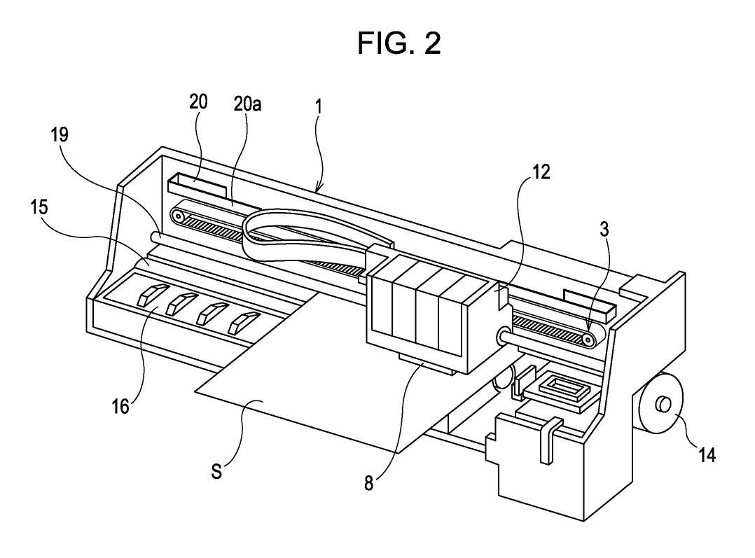

FIG. 1 is a block diagram illustrating the electric configuration of a printer 1. FIG. 2 is a perspective view illustrating the inner configuration of the printer 1.

The exemplary printer 1 ejects liquid ink toward a recording medium S such as a recording sheet, a cloth, or a resin film. The recording medium S serves as a landing target for the liquid. A computer CP serving as an external apparatus is connected to the printer 1 so as to be communicable with the printer 1. The computer CP transmits print data of an image to the printer 1 to instruct the printer 1 to print the image.

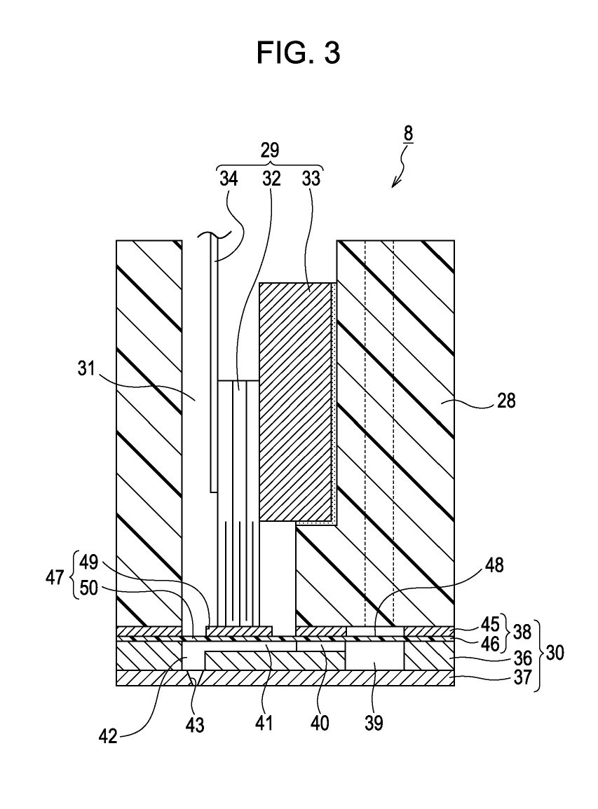

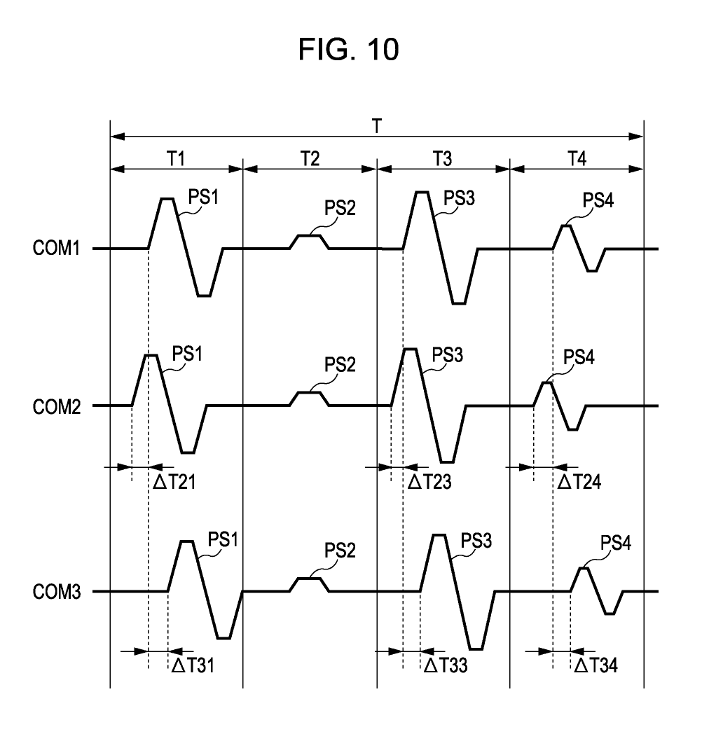

The printer 1 according to this embodiment includes a transport mechanism 2, a carriage movement unit or mechanism 3, a driving signal generation unit or circuit 4, a head unit 5, a detector group 6, and a printer controller or control unit 7. The transport mechanism 2 transports the recording medium S in a transport direction. The carriage movement mechanism 3 moves a carriage, mounted with the head unit 5, in a different direction (for example, a sheet width direction). The driving signal generation circuit 4 includes a Digital Analog Converter (DAC, not shown), and generates an analog voltage signal based on waveform data of a driving signal transmitted from the printer controller 7. The driving signal generation circuit 4 includes an amplification circuit (not shown) and amplifies the voltage signal from the DAC and generates a driving signal COM. In the illustrated embodiment, the driving signal generation circuit 4 can generate three kinds of driving signals: COM1, COM2, and COM3. The driving signals COM are applied to piezoelectric vibrators 32 (see FIG. 3) of a recording head 8 when printing on the recording medium. The driving signals COM are a series of signals including at least one ejecting pulse PS in a period T of the driving signal COM, as shown in FIG. 10. The ejection pulse PS enables the piezoelectric vibrator 32 to eject an ink droplet from the recording head 8. Each driving signal COM will be described in detail below.

The head unit 5 includes the recording head 8 and a head control unit 11. The recording head 8, or liquid ejecting head 8, forms dots by ejecting the ink onto the recording medium S, which dots or drops land on the recording medium to form images. An image or the like is recorded on the recording medium S by the plurality of dots which have landed from the liquid ejection head. The head control unit 11 controls the recording head 8 based on a head control signal from the printer controller 7. The recording head 8 will be described in more detail below. The detector group 6 includes a plurality of detectors detecting the status of the printer 1, including a gap detector (not shown) which detects the distance between the nozzle surface (the surface of a nozzle plate 37 from which the ink is ejected) of the recording head 8 and the surface on which the ink lands on the recording medium S, on the platen 16. The size of the gap is output to the printer controller 7, which controls the printer 1 on the whole. The gap detector includes a light-emitting unit which emits laser light toward the recording medium S from the side of the nozzle surface of the recording head 8, and a light-receiving unit which receives light reflected from, or sent from or through, the recording medium S. The gap detector detects the distance based on the detection result of the light-receiving unit.

The transport mechanism 2 transports the recording medium S in a transport direction, which is usually perpendicular to the scanning direction of the recording head 8. The transport mechanism 2 includes a transport motor 14, a transport roller 15, and the platen 16. The transport roller 15 transports the recording medium S up to the platen 16, which is a printable area, and is driven by the transport motor 14. The platen 16 supports the recording medium S which is being subjected to the printing.

The printer controller 7 includes an interface unit 24, a CPU 25, and a memory unit 26. The interface unit 24 transmits or receives data between the computer CP and the printer 1. The CPU 25 is an arithmetic processing unit which controls the entire printer. The memory 26 provides an area used to store the programs of the CPU 25, a working area, or the like. The memory 26 includes a storage element such as a random access memory (RAM) or an Electrically Erasable Programmable Read-Only Memory (EEPROM). The CPU 25 controls each unit in accordance with a program stored in the memory 26.

As shown in FIG. 2, a carriage 12 is slidably mounted on and axially supported by a guide rod 19 along the main scanning direction. Therefore, the carriage 12 is slidable in the main scanning direction along the guide rod 19 when the carriage movement mechanism 3 operates. The position of the carriage 12 in the main scanning direction is detected by a linear encoder 20. A signal or encoder pulse indicative of position, detected by the linear encoder 20, is transmitted to the CPU 25 of the printer controller 7. The linear encoder 20 acts as a position information output unit outputting the encoder pulse corresponding to the scanning position of the recording head 8. The linear encoder 20 according to the illustrated embodiment includes a scale or encoder film 20a installed in the main scanning direction inside the case of the printer 1 and a photo interrupter (not shown) installed on the rear surface of the carriage 12. In some embodiments, the scale 20a may be a band of transparent resin film with opaque stripes printed on its surface. The stripes are formed in the longitudinal direction of the scale and have the same width at a constant pitch, for example, a pitch corresponding to 180 dpi. The photo interrupter includes a light-emitting element and a light-receiving element facing each other (or otherwise arranged to cooperate with one another), and is configured to output an encoder pulse indicative of either a light-received state (in the transparent portion of the scale 20a) or a light-received state (in the stripe portion thereof).

Because the stripes have the same width, an encoder pulse EP is output at a constant interval when the speed of the carriage 12 is constant, but varies when the speed of the carriage 12 is not constant (during acceleration or deceleration). The encoder pulse EP is input to the printer controller 7, which recognizes the position of the recording head 8 based on the encoder pulse EP. That is, the position of the carriage 12 is recognized by counting the encoder pulses EP. Thus, the printer controller 7 controls the recording head 8 based on the position of the carriage 12. The printer 1 may be configured to perform so-called bidirectional recording, i.e. can print in both directions: forward (in which the carriage 12 moves from a home position to a full position) and backward (in which the carriage 12 returns from the full position to the home position).

The encoder pulse EP from the linear encoder 20 is input to the printer controller 7, which generates a timing pulse, or Print Timing Signal (PTS) based on the encoder pulse EP, and then transmits the print data or generates the driving signal COM in synchronization with the timing pulse PTS. The driving signal generation circuit 4 outputs the driving signal COM at a timing which is based on the timing pulse PTS. The printer controller 7, in some embodiments, can generate a timing signal such as a latch signal LAT based on the timing pulse PTS and outputs the timing signal to the recording head 8. The latch signal LAT is a signal which can define a start timing of a record period. Therefore, the period T of the driving signal COM (see FIG. 10) can be defined by the latch signal LAT.

Next, the configuration of the recording head 8 will be described with reference to FIG. 3.

The recording head 8 includes a case 28, a vibrator unit 29 received in the case 28, and a passage unit 30 joined to the bottom surface of the case 28. The case 28 is formed of, for example, epoxy-based resin. A receiving hollow portion 31 is formed inside the case to receive the vibrator unit 29. The vibrator unit 29 includes a piezoelectric vibrator 32 serving as a pressure generation unit, a fixing plate 33 to which the piezoelectric vibrator 32 joins, and a flexible cable 34 supplying a driving signal to the piezoelectric vibrator 32. The piezoelectric vibrator 32 is a laminated type unit including a piezoelectric plate, including alternating piezoelectric layers and electrode layers, in a pectinate form. The vibrator 32 is a vertical vibration mode piezoelectric vibrator expandable and contractible (of electric field lateral effect type) in a direction perpendicular to the lamination direction (electric field direction).

The passage unit 30 includes a nozzle substrate 37 joined to one surface of a passage substrate 36, and a vibration plate 38 joined on the other surface of the passage substrate 36. A reservoir or common liquid chamber 39, an ink supply port 40, a pressure chamber 41, a nozzle communication opening 42, and a nozzle 43 are defined in the passage unit 30. A series of ink passages lead from the ink supply port 40 to each nozzle 43 via the pressure chamber 41 and the nozzle communication opening 42.

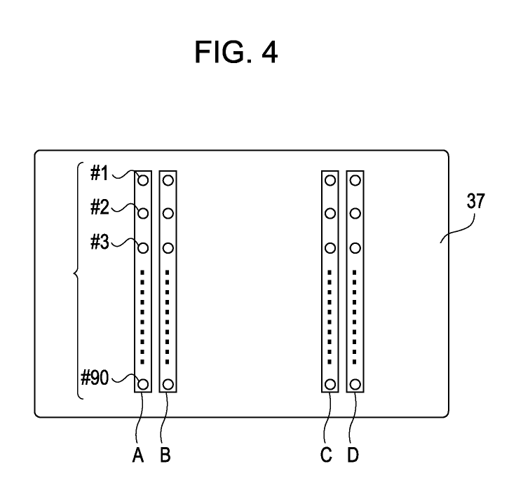

FIG. 4 is a plan view illustrating the configuration of the nozzle plate 37. In FIG. 4, the horizontal direction is a main scanning direction in which the recording head 8 moves relative to the recording medium S and the vertical direction is the transport direction of the recording medium S, that is, a sub-scanning direction. The nozzle plate 37 defines a plurality (for example, ninety) of nozzles 43 punched in rows in the sub-scanning direction at a pitch (for example, 180 dpi) corresponding to a dot formation density. The nozzle plate 37 may be made of, for example, stainless steel or a silicon single crystalline substrate. In the illustrated embodiment, four nozzle rows A to D are provided.

The vibration plate 38 is two-layered, and includes an elastic film 46 on the surface of a support plate 45. The vibration plate 38 may be a composite plate member including a stainless plate as the support plate 45 and laminating a resin film as the elastic film 46. The vibration plate 38 is provided with a diaphragm portion 47 for varying the volume of the pressure chamber 41 and a compliance portion 48 sealing a part of the reservoir 39.

The diaphragm portion 47 may be manufactured by partially removing the support plate 45 by etching. That is, the diaphragm portion 47 includes an island 49 to which the front end surface of the piezoelectric vibrator 32 joins, and a thin-walled elastic portion 50 surrounding the island 49. The compliance portion 48 may be similarly manufactured by removing the support plate 45 of a region facing the reservoir 39 by etching. The compliance portion 48 functions as a damper absorbing changes in the pressure of ink stored in the reservoir 39.

Since the front end surface of the piezoelectric vibrator 32 joins to the island 49, the volume of the pressure chamber 41 can be changed by expanding or contracting the free end portion of the piezoelectric vibrator 32. A change in the pressure of the ink in the pressure chamber 41 is caused with the variation in the volume. The recording head 8 ejects ink droplets from the nozzles 43 using the change in the pressure.

Next, adjustment of the landing position will be described.

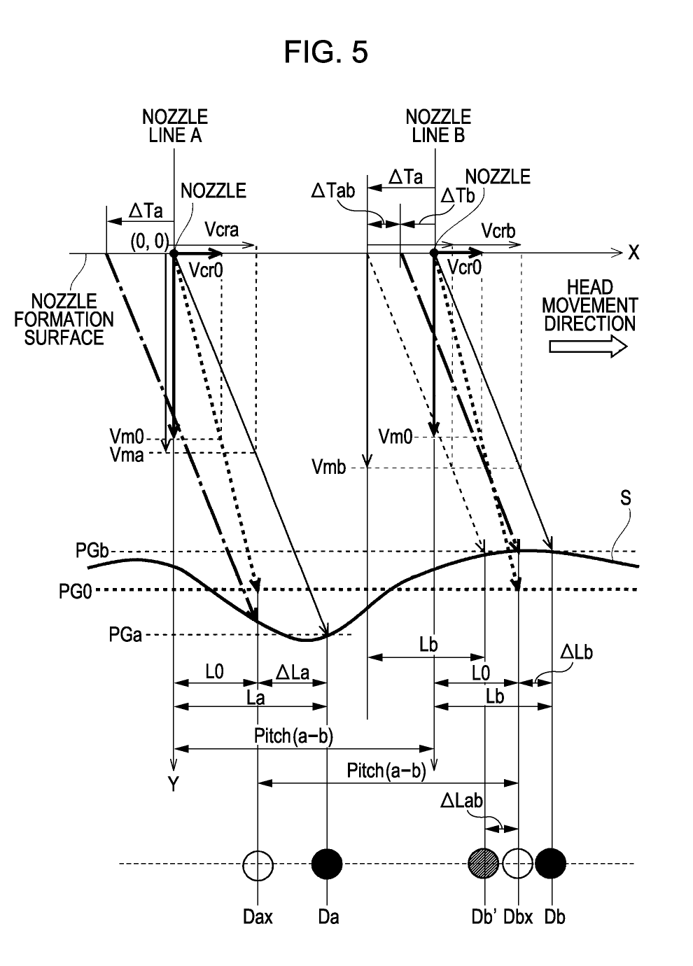

FIG. 5 is a schematic diagram illustrating the variations of the landing position of ink caused due to curving of the recording medium S if the landing position were not adjusted, and the adjusted position, when the ink is ejected from the nozzles 43 of the recording head 8 onto the recording medium S. The printer 1 according to this embodiment is configured to eject the ink by selecting an appropriate ejection timing. As described below, if it were not adjusted, the landing position of the ink would vary due to variations in the vertical distance between the nozzle 43 and the intended landing position on the recording medium S (also referred to herein as a platen gap PG). Therefore, the ink is controlled to land on its intended position by adjusting the ejection timing of the ink. The ejection timing is set in accordance with the difference between the actual platen gap PG and a reference platen gap PG0, an ideal state where curving of the recording medium S does not occur.

In FIG. 5, for example, two nozzles A and B are illustrated in the recording head 8. The recording head 8 ejects the ink toward the recording medium S while moving from the left side to the right side of the drawing. The distance between the nozzle lines A and B is illustrated as Pitch (a−b). It is assumed that the nozzle 43 of the nozzle line A is the origin (0, 0) (when the timing adjustment is performed with reference to the nozzle line B, the nozzle 43 of the nozzle line B is the origin (0, 0)) and the X axis matches with the nozzle surface. The direction (vertical direction) perpendicular to the nozzle surface is the Y axis. Vcr denotes a speed of the recording head 8 and the carriage 12 relative to the recording medium S (which may in some embodiments be the speed of the recording medium S, if the position of the recording head 8 is fixed and the recording medium S is moved relative to the recording head 8). Because the carriage 12 accelerates and decelerates in the width direction of the recording medium S, Vcra and Vcrb may not be the same as Vcr0. Vm denotes a speed component of the ink in a Y axis direction and is, in some embodiments, an average speed over the time the ink is in the air. The actual speed of the ink changes every moment due to air resistance and the like from the nozzle 43 to the recording medium S. The average speed is used in some embodiments. Vm is different depending on the platen gap PG. The details thereof will be described below. L denotes the distance the ink travels in an X axis direction from the nozzle 43 to the landing position.

In FIG. 5, PG0 indicates the position of the recording surface of the recording medium S in the Y axis direction in the ideal state, where the recording medium S is not curved or wrinkled (e.g. due to the cockling effect). However, since the recording medium S may actually be curved or cockled, PG may not be constant when viewed in the X axis direction, as illustrated by the curved line S. The landing position on the recording medium S is illustrated in the undermost portion of the drawing in a plan view. The white circles are the intended, ideal landing positions. The landing position corresponding to the nozzle line A on the X axis is illustrated as Dax and the landing position corresponding to the nozzle line B on the X axis is illustrated as Dbx. The black circles are landing positions of the ink when the timing is not adjusted in accordance with embodiments of the present invention (the first driving signal COM1 [see FIG. 10]). The landing position corresponding to the nozzle line A on the X axis is illustrated as Da and the landing position corresponding to the nozzle line B illustrated as Db. The platen gap PGa at Da is different from the platen gap PGb at Db, and both the platen gaps PGa and PGb are different from PG0.

Suffixes a, b, and 0 of a speed component Vm, a time component T, and a distance component L correspond to nozzle line A, nozzle line B, and the ideal landing position PG0, respectively.

First, a method of calculating an adjustment time ΔTa of nozzle line A will be described.

If the timing adjustment were not adjusted, the landing position Da would deviate by ΔLa from the intended landing position Dax in the head movement direction, that is, downstream in the main scanning direction. Therefore, the ejection timing is advances, i.e. the ink is ejected earlier than it otherwise would be, to adjust its position by ΔLa. The adjustment time corresponding to ΔLa is defined by ΔTa. Here, ΔLa=La−L0. Moreover:

L0=Vcr0×PG0/Vm0

La=Vcra×PGa/Vma

The adjustment time ΔTa can be calculated as follows.

$$\begin{matrix}Δ Ta = - Δ La / Vcra \\ = - ( La - L 0 ) / Vcra = ( L 0 - La ) / Vcra \\ = \{ ( Vcr 0 \times PG 0 / Vm 0 ) - ( Vcra \times PGa / Vma ) \} / Vcra \\ = ( Vcr 0 \times PG 0 / Vm 0 ) / Vcra - PGa / Vma \\ = ( PG 0 / Vm 0 ) \times \{ Vcr 0 / Vcra - ( PGa / PG 0 ) / ( Vma / Vm 0 ) \}\end{matrix} \qquad ( 1 )$$

Expression (1) indicates that the ejection timing of the ink from the nozzle 43 of the nozzle line A is advanced from the reference time. When ΔTa is positive, the ejection timing is delayed from the reference time, and when ΔTa is negative, the ejection timing is advanced from the reference time.

A method of calculating the adjustment amount of the ejection timing for nozzle line B and the other nozzle lines is the same as that for nozzle line A. As for nozzle line B, in the example shown in FIG. 5, the ejection timing of nozzle line B is advanced so that the ink lands upstream by ΔLb. The adjustment time corresponding to ΔLb is defined by ΔTb. Here, ΔLb=Lb−L0, where L0 is the same as above, and Lb satisfies the following expression. Vcra and Vcrb may not be same as Vcr0, because the carriage 12 accelerates and decelerates in the width direction of the recording medium S. However, Vcra≈Vcrb, since the difference between the ejection timings ΔTab of the nozzle lines is small and thus the carriage 12 does not speed up or slow down considerable in such a short time.

Lb=Vcrb×PGb/Vmb

The adjustment time ΔTb can be calculated as follows.

$$\begin{matrix}Δ Tb = - Δ Lb / Vcrb \\ = - ( Lb - L 0 ) / Vcrb = ( L 0 - Lb ) / Vcrb \\ = \{ ( Vcr 0 \times PG 0 / Vm 0 ) - ( Vcrb \times PGb / Vmb ) \} / Vcrb \\ = ( Vcr 0 \times PG 0 / Vm 0 ) / Vcrb - PGb / Vmb \\ = ( PG 0 / Vm 0 ) \times \{ Vcr 0 / Vcrb - ( PGb / PG 0 ) / ( Vmb / Vm 0 ) \}\end{matrix} \qquad ( 2 )$$

As in Expression (1), in Expression (2), when ΔTb is positive, the ejection timing is delayed from the reference time, and when ΔTb is negative, the ejection timing is advanced from the reference time.

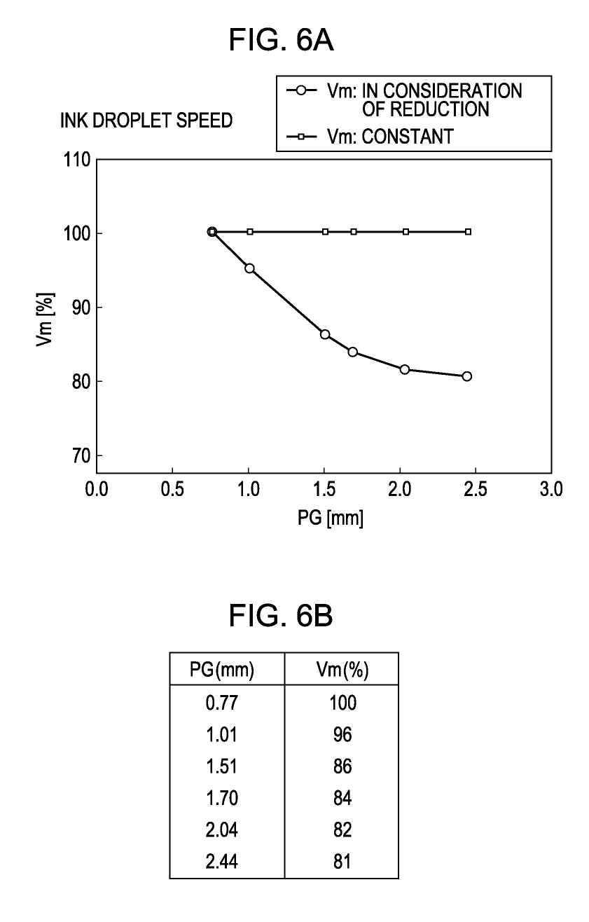

FIG. 6A is a graph illustrating the average speed Vm in the Y-axis direction of FIG. 5 of the ink for the platen gap PG. In FIG. 6A, the horizontal axis represents the size of the platen gap PG and the vertical axis represents the average speed Vm. The average speed Vm is expressed as a ratio when the platen gap PG of 0.77 mm is 100%. FIG. 6B is a table illustrating the platen gap PG and the average speed Vm of the ink which correspond to each other. Expressions (1) and (2) allow adjustments of the ejection timing assuming the average speed Vm of the ink does not vary with the platen gap PG. However, the actual average speed Vm of the ink changes together with the change in the platen gap PG and the relationship is not linear.

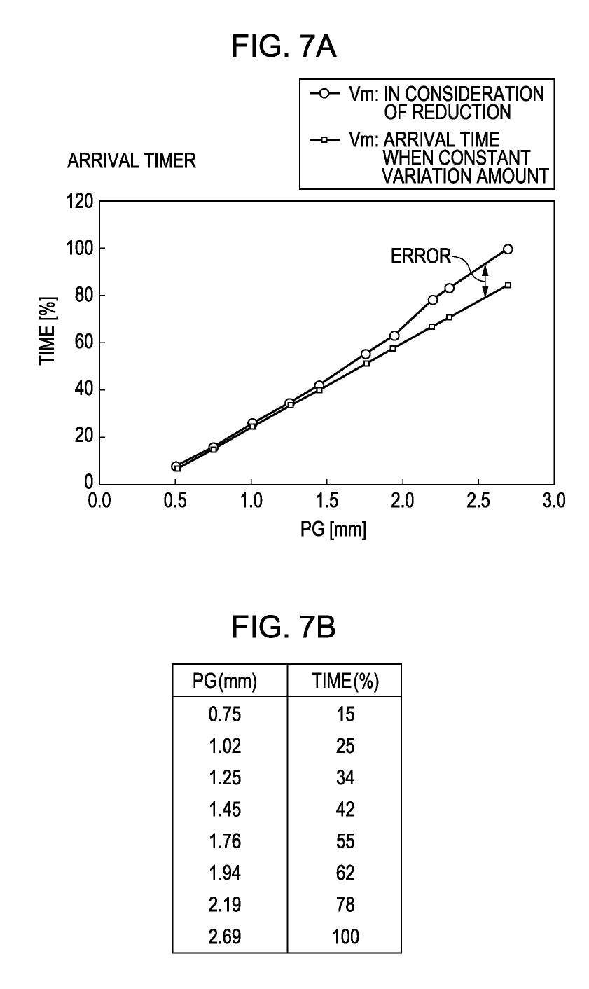

FIG. 7A is a graph illustrating an arrival time at which the ink arrives on the recording medium S after crossing the platen gap PG. In FIG. 7A, the horizontal axis represents the size of the platen gap PG and the vertical axis represents the arrival time. The arrival time is expressed as a ratio when the arrival time in the platen gap PG of 2.69 mm is 100%. FIG. 7B is a table illustrating the platen gap PG and the arrival time of the ink which correspond to each other. In FIGS. 7A and 7B, the platen gap PG and the arrival time are substantially linearly related when the platen gap is relatively small (0.5 mm˜1.0 mm). However, when the platen gap PG is larger, the linear relationship is not satisfied.

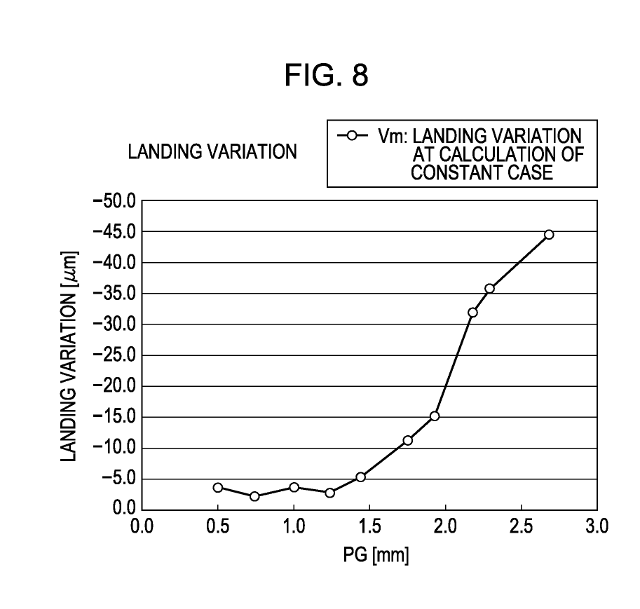

FIG. 8 is a graph illustrating a landing variation of the ink for the platen gap PG in an embodiment in which Vm is assumed to be constant regardless of the size of the platen gap PG. In FIG. 8, the horizontal axis represents the size of the platen gap PG and the vertical axis represents a variation in the X axis direction of the landing position. As shown in FIG. 8, the variation of the landing position is relatively small when the platen gap PG is small (e.g. about 0.5 mm-about 1.0 mm), but increases as the platen gap PG is larger.

Thus, when the platen gap PG changes, the landed ink deviates from the intended position although the ejection timing of the ink is adjusted assuming a constant average speed of the ink. Therefore, in other embodiments, the ejection timing of the ink is adjusted in consideration of the change in the average speed Vm of the ink when the platen gap PG changes.

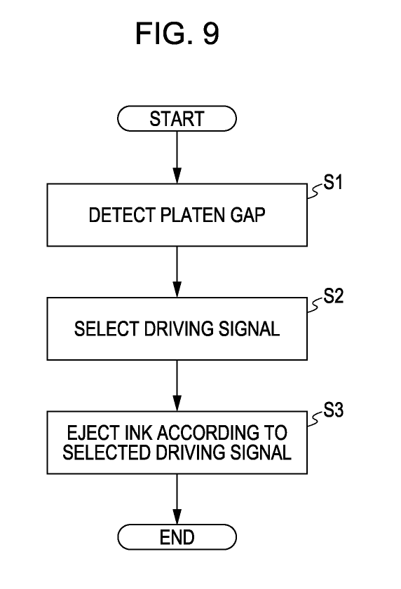

FIG. 9 is a flowchart illustrating adjustment of the landing position of the ink, that is, a process of adjusting the ejection timing of the ink according to some embodiments.

First, the platen gap PG in the main scanning direction on the recording medium S is calculated (S1). As described above, in some embodiments, the recording head 8 scans the recording medium S so that the gap detector can dynamically detect the platen gap PG, before ejecting the ink on the recording medium S. Thus, the platen gap PG is detected according to the scanning position of the recording head 8 for the recording medium S. The invention is not limited to any particular method of detecting the platen gap PG. Instead, the platen gap may be estimated from the shape of cockling by allowing the recording medium S to cockle on purpose by the transport roller 15, the platen 16, or the like (that is, adjusting the cockling to follow the shape of the platen or the like). In this embodiment, a change range of the platen gap of the recording medium S is obtained by the gap detector, an incrementalized plurality of platen gap levels is set (for example, at three increments) within the change range, and the increment close to the detected platen gap among the platen gap levels is used as the platen gap PG used at adjustment. At least PG0 (the ideal state) may be included in the platen gap levels. Since the platen gap of the recording medium S is sometimes different depending on the position in the head movement direction, that is, the main scanning direction, the platen gap PG is stored in the memory 26 in correspondence with information regarding the position in the main scanning direction.

Next, the driving signal COM is selected for each nozzle line based on the platen gap PG. If the timing of each driving pulse of the driving signal is adjusted for each precise platen gap without utilizing the platen gap increments, each adjustment time of the ink droplets is sequentially calculated based on the detected platen gap PG. A value for the average speed Vm is calculated corresponding to the detected or approximated platen gap PG. Therefore, a lookup table between the platen gap PG and the average speed Vm, as in FIG. 6B, or an arithmetic expression used to calculate the average speed Vm is stored in the memory 26 of the printer 1. An adjustment time ΔT can be calculated by substituting each value to Expression (1) above.

In embodiments in which the platen gap is incrementalized into levels, as shown in FIG. 10, the number of driving signals COM (in this embodiment, three driving signals COM1 to COM3) only need to be the same as the number of the platen gap levels so that each driving signal COM corresponds to one platen gap level. That is, the timing of the ejection pulse of each driving signal COM is adjusted only by a value calculated by substituting each value (average speed or the like) determined according to the corresponding platen gap level to Expression (1). Thus, the driving signal generation circuit 4 is configured to generate the driving signals COM1 to COM3 in which the timing is set based on the platen gap PG, the average speed Vm calculated based on the corresponding platen gap PG, or the arrival time and the carriage movement speed Vcr. By utilizing such a configuration, it is possible to shorten the processing time without sequentially calculating each adjustment time of the ejection timing of the ink droplet. Moreover, the circuit generating the driving signal can be as small as possible.

In this embodiment, as shown in FIG. 10, the driving signal COM includes a first driving pulse PS1, a second driving pulse PS2, a third driving pulse PS3, and a fourth driving pulse PS4 within a unit period T. The unit period T, which is a period of the driving signal COM, corresponds to one pixel at the relative speed between the recording head 8 and the recording medium S. One of the driving pulses is selectively applied to the piezoelectric vibrator 32 for one pixel and an ink droplet is ejected from the nozzle 43 to form a dot with each size. In the illustrated embodiment, it is possible to form three kinds of dots: a large dot, a middle dot, and a small dot. The first driving pulse PS1 in section T1 of the unit period T generates a medium-sized ink droplet The second driving pulse PS2 in section T2 minutely vibrates a meniscus in the nozzle 43 to such a small degree that an ink droplet is not ejected. The third driving pulse PS3 generates a large ink droplet. The fourth driving pulse PS4 in section T4 generates a small ink droplet. The invention is not limited to the shape of each driving pulse, but various waveforms are used according to the amount or the like of the ink ejected from the nozzle 43.

The first driving signal COM1 serves as a reference corresponding to the ideal PG0. Therefore, when the detected platen gap corresponds to PG0, the first driving signal COM1 is selected. The second driving signal COM2 advances the timing of each driving pulse (excluding PS2) compared to COM1. The third driving signal COM3 delays the timing of each driving pulse (excluding PS2) compared to COM1. The illustrated embodiment includes three driving signals COM1 to COM3 corresponding to three platen gap levels, but the invention is not limited thereto. Instead, a greater number of platen gap levels may be set and an equal number of driving signals COM may be provided. Thus, it is possible to adjust the timing more minutely. The adjustment time ΔT of the driving pulse is different for each driving pulse, that is, the size of the dot, which will be described below. In the illustrated embodiment, the timing of PS2 is not adjusted, but the invention is not limited thereto

The printer 1 selects the driving signal COM for each nozzle line and ejects the ink based on the selected driving signal COM (S3). As described above, the platen gap of the recording medium S is sometimes different depending on the position in the main scanning direction. Therefore, the platen gap PG is read for each nozzle line from the memory 26. The driving signals COM corresponding to the read platen gaps PG are sequentially selected for each nozzle line. Thus, even when the recording medium S is cockled, and thus the platen gap PG is different depending on the position in the main scanning direction, the ink droplet ejected from the nozzle 43 of each nozzle line lands on or very near the intended position on the recording medium S. Accordingly, it is possible to prevent variation in the landing position of the ink on the recording medium S. As a consequence, when an image or the like is recorded on the recording medium S, the image quality is high.

In the embodiments described above, the adjustment time ΔT is calculated based on the average speed of the ink Vm, but the invention is not limited thereto. For example, the adjustment time ΔT may be calculated based on the arrival time at which the ink droplet lands on the recording medium S. The arrival time is selected according to the platen gap PG detected based on a lookup table such as FIG. 7B or calculated in the memory 26. In addition, when the adjustment time ΔT is calculated, the average speed Vm of the ink can be calculated by dividing the platen gap PG by the arrival time. Thereafter, the ejection timing of the ink can be adjusted in the same way as the way described above.

When the sizes of the ink droplets ejected from the nozzles 43 are different, the average speed Vm of the ink is sometimes different, because the air resistance or the like is different due to the size of the ink droplet. Moreover, the sizes of the ink droplets ejected in different print modes, such as a high speed printing mode or a high resolution printing mode, are different. Therefore, the average speed of the ink is different. In general, in the high speed printing mode, the dots tend to be formed in broader areas on the recording medium S by ejecting larger ink droplets, whereas in the high resolution printing mode, the dots tend to be formed in narrower areas on the recording medium S by ejecting smaller ink droplets. Accordingly, the driving signals COM may be different for each printing mode and the adjustment time ΔT for each driving pulse corresponding to each dot size may be set for each driving signal COM (see FIG. 10). Thus, it is possible to eject the ink at more appropriate timing even with different printing modes and their resulting different sizes of the ink droplets.

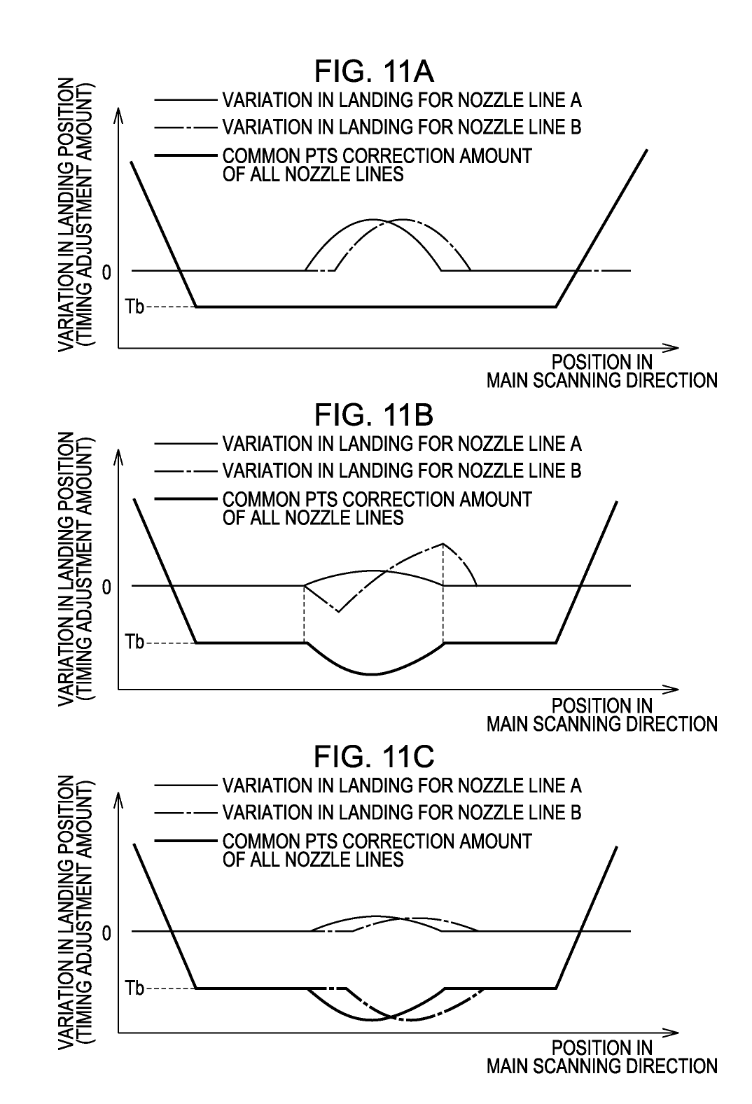

FIG. 11A is a diagram illustrating a variation in the landing position when the ink is ejected from the nozzle lines A and B to land on the recording medium S. In FIG. 11A, the horizontal axis represents the position in the main scanning direction of the recording medium S and corresponds to the X axis direction in FIG. 5. The vertical axis represents the degree of the variation in the landing position of the ink droplet and 0 represents the landing position corresponding to PG0. Therefore, upward corresponds to the ink deviating in the downstream direction, and downward corresponds to the upstream direction. Moreover, the vertical axis also represents the timing adjustment amount of the ejection timing. In FIG. 11A, the vertical axis represents the adjustment time corresponding to the driving signal COM1. As the adjustment time (adjustment amount) goes upward, the timing is delayed more than a reference Tb. As the adjustment time goes downward, the timing is advanced more than the reference Tb. In the drawing, a solid line indicates the landing position corresponding to the nozzle line A and a one-dot chain line indicates the landing position corresponding to the nozzle line B. A bold solid line indicates the timing adjustment amount. The same adjustment amount is applied to each nozzle line in FIGS. 11A-11C. The reason for changing the timing adjustment amount at the left and right ends of the graph is the acceleration and deceleration of the carriage 12 near the ends of its travel. When the ejection timing of the ink is adjusted without taking the change in the platen gap PG into consideration, as shown in FIG. 11A, it can be understood that the variation in the landing position occurs due to the change in the platen gap PG in both nozzle line A and nozzle line B.

FIG. 11B is a diagram illustrating a variation in the landing position when the ejection timing is adjusted by the same amount for both the nozzle lines A and B. In this example, the driving signal COM is selected according to the platen gap PG of nozzle line A and is used commonly for all of the nozzle lines. In this case, since the ink is ejected at an appropriate timing for the nozzle line A, the variation in the landing position is minimized. However, when the ink is ejected from nozzle line B, the platen gap PG is different from that for the nozzle line A. Therefore, it can be understood that an appropriate adjustment is not applied to nozzle line B, and variation in the landing position occurs. That is, in the example shown in FIG. 5, the landing position Db′ of the ink droplet ejected from the nozzle 43 of the nozzle line B may be varied by ΔLab from the intended landing position Dbx in the upstream direction, when the ejection timing is advanced by an adjustment time ΔTa for both the nozzle lines A and B. Accordingly, it is preferable to adjust the ejection timing for each nozzle line.

FIG. 11C is a diagram illustrating a variation in the landing position when the ejection timing is adjusted for each nozzle line. In this example, the driving signal COM is selected according to each platen gap PG for each nozzle line and the ink is ejected based on the corresponding driving signal COM. In this case, since the ink is ejected at an appropriate timing for each nozzle line, it is possible to minimize the variation in the landing position in both the nozzle lines A and B.

The invention is not limited to the above-described embodiments, but may be modified in various forms within the scope of the claims of the invention.

In the above-described embodiment, the ink is ejected while the recording head 8 is moved relative to the recording medium S, but the invention is not limited thereto. For example, the position of the recording head 8 may be fixed and the ink may be ejected while the recording medium S is moved relative to the recording head 8. That is, the invention is applicable to any configuration in which the ink is ejected onto the recording medium S while the recording head 8 and the recording medium S are relatively moved.

In the above-described embodiment, the so-called vertical vibration type piezoelectric vibrator 32 is used as the pressure generation unit, but the invention is not limited thereto. For example, a so-called bending vibration piezoelectric element may be used. In this case, waveforms inverted in a change direction of potential, that is, a vertical direction are used for the ejection pulses PS exemplified in the above-described embodiment.

The pressure generation unit is not limited to a piezoelectric element. The invention is applicable even when various kinds of pressure generation units, such as a heating element, generating bubbles in a pressure chamber, or an electrostatic actuator, changing the volume of a pressure chamber using an electrostatic force, are used.

As described above, the ink jet printer 1 which is a kind of liquid ejecting apparatus has been described as an example. However, the invention is applicable to any liquid ejecting apparatus which ejects a liquid while a liquid ejecting head and a landing target are relatively moved. For example, the invention is applicable to a display manufacturing apparatus which manufactures a color filter such as a liquid crystal display, an electrode manufacturing apparatus which manufactures an electrode such as an organic EL (Electro Luminescence) display or an FED (Field Emission Display), a chip manufacturing apparatus which manufactures a bio chip (bio-chemical chip), a micropipette which supplies a very small amount of a sample solution exactly, and the like.

The entire disclosure of Japanese Patent Application No. 2010-108203, filed May 10, 2008 is expressly incorporated by reference herein.

What is claimed is:

1. A liquid ejecting apparatus, comprising:
a liquid ejecting head including a plurality of nozzle groups each having a plurality of nozzles, each nozzle being configured to eject a liquid onto a landing target by an ejection pulse applied to the liquid;
a movement unit relatively moving the liquid ejecting head and the landing target;
a control unit which sets an ejection timing of the liquid from the nozzles for each nozzle group according to a distance between the nozzles and the landing target; and
a driving signal generation unit which generates driving signals including the ejection pulses, wherein a timing of each ejection pulse is based on the distance and a speed of the liquid as the liquid crosses the distance;
wherein the control unit selects the driving signal for each nozzle group based on the distance and applies a corresponding ejection pulse to the liquid.

2. The liquid ejecting apparatus according to claim 1, wherein the liquid ejecting head is further configured to eject the liquid in a plurality of ejection modes, wherein timing of the ejection pulse varies with the ejection mode, and wherein the control unit selects the driving signal for each ejection mode and each nozzle group.

3. The liquid ejecting apparatus according to claim 2, wherein the ejection modes comprise different sizes of liquid droplets.

4. The liquid ejecting apparatus according to claim 1, wherein the ejection pulses have sizes corresponding to sizes of dots formed by the liquid landing on the landing target.

5. The liquid ejecting apparatus according to claim 1, wherein the speed is an average speed between the liquid ejecting head and the landing target.

6. The liquid ejecting apparatus according to claim 1, wherein the speed is determined based on a time that the liquid takes to cross the distance, and a relative speed between the liquid ejecting head and the landing target.

7. The liquid ejecting apparatus according to claim 1, wherein the speed on which the ejection pulse is based comprises a component in the direction perpendicular to the direction of relative movement between the liquid ejecting head and the landing target.

8. The liquid ejecting apparatus according to claim 1, wherein the speed on which the ejection pulse is based comprises a component in the direction of relative movement between the liquid ejecting head and the landing target.

9. The liquid ejecting apparatus according to claim 1, wherein the distance is approximated to a nearest one of a plurality of discrete, pre-selected distances, and the driving signals each correspond to one of the pre-selected distances.

10. The liquid ejecting apparatus according to claim 9, wherein the driving signals comprise a normal timing driving signal, an advanced timing driving signal, and a delayed timing driving signal.

11. A liquid ejecting method for ejecting a liquid from a plurality of nozzles of a plurality of nozzle groups of a liquid ejecting head onto a landing target by applying an ejection pulse to the liquid, comprising:
relatively moving the liquid ejecting head and the landing target;
setting an ejection timing of the liquid from the nozzles for each nozzle group according to a distance between the nozzles and the landing target;
generating driving signals including the ejection pulses, wherein a timing of each ejection pulse is based on the distance and a speed of the liquid as the liquid crosses the distance; and
selecting the driving signal for each nozzle group based on the distance and applying a corresponding ejection pulse to the liquid.

12. The liquid ejecting method according to claim 11, further comprising ejecting the liquid in a plurality of ejection modes, wherein timing of the ejection pulse varies with the ejection mode, and wherein selecting the driving signal comprises selecting the driving signal for each ejection mode and each nozzle group.

13. The liquid ejecting method according to claim 12, wherein the ejection modes comprise different sizes of liquid droplets.

14. The liquid ejecting method according to claim 11, wherein the ejection pulses have sizes corresponding to sizes of dots formed by the liquid landing on the landing target.

15. The liquid ejecting method according to claim 11, wherein the speed is an average speed between the liquid ejecting head and the landing target.

16. The liquid ejecting method according to claim 11, further comprising determining the speed based on a time that the liquid takes to cross the distance, and a relative speed between the liquid ejecting head and the landing target.

17. The liquid ejecting method according to claim 11, further comprising approximating the distance to a nearest one of a plurality of discrete, pre-selected distances, wherein the driving signals each correspond to one of the pre-selected distances.

18. The liquid ejecting method according to claim 17, wherein the driving signals comprise a normal timing driving signal, an advanced timing driving signal, and a delayed timing driving signal.

19. The liquid ejecting method according to claim 9, wherein the speed on which the ejection pulse is based comprises a component in the direction perpendicular to the direction of relative movement between the liquid ejecting head and the landing target.

20. The liquid ejecting method according to claim 9, wherein the speed on which the ejection pulse is based comprises a component in the direction of relative movement between the liquid ejecting head and the landing target.
